(19) United States
(12) Patent Application Publication
(10) Pub. No.: US 2026/0278955 A1
(43) Pub. Date: Sep. 17, 2026

(54) COMMUNICATION TERMINAL, COMMUNICATION SYSTEM, COMMUNICATION METHOD, AND NON-TRANSITORY RECORDING MEDIUM

(71) Applicants: Takeshi HORIUCHI, Tokyo (JP); Kenichiro MORITA, Tokyo (JP)

(72) Inventors: Takeshi HORIUCHI, Tokyo (JP); Kenichiro MORITA, Tokyo (JP)

(21) Appl. No.: 19/554,841

(22) Filed: Mar. 3, 2026

(30) Foreign Application Priority Data
Mar. 12, 2025 (JP) 2025-039203
Nov. 20, 2025 (JP) 2025-201089

(51) Int. Cl. G06T 19/00; G06T 5/50; G06T 7/73

(52) U.S. Cl. CPC G06T 19/006; G06T 5/50; G06T 7/73; G06T 2207/20221

(57) ABSTRACT

A communication terminal includes circuitry that displays a video captured by an image capturing apparatus, acquires a three-dimensional model associated with an object to be masked, when the object to be masked is included in the video, and displays the video in which the acquired three-dimensional model is superimposed on the object to be masked.

### CROSS-REFERENCE TO RELATED APPLICATIONS

This patent application is based on and claims priority pursuant to 35 U.S.C. § 119(a) to Japanese Patent Application Nos. 2025-039203, filed on Mar. 12, 2025, and 2025-201089, filed on Nov. 20, 2025, in the Japan Patent Office, the entire disclosure of which is hereby incorporated by reference herein.

### BACKGROUND

### Technical Field

The present disclosure relates to a communication terminal, a communication system, a communication method, and a non-transitory recording medium.

### Related Art

A technique provides for remote tours of workplaces such as food factories using remote communication technology such as teleconferencing.

The technique involves, for example, detecting coordinates of a facial region from captured video data, generating masking data based on the detected coordinates, and superimposing the masking data on the original video data, thereby generating video data in which the facial region in a video is masked.

### SUMMARY

The present disclosure described herein provides a communication terminal including circuitry. The circuitry displays a video captured by an image capturing apparatus, acquires a three-dimensional model associated with an object to be masked, when the object to be masked is included in the video, and displays the video in which the acquired three-dimensional model is superimposed on the object to be masked.

The present disclosure described herein provides a communication system including the above-described communication terminal and an information processing system including system circuitry. The system circuitry distributes a video on which mask processing for superimposing the three-dimensional model on the object to be masked has been performed.

The present disclosure described herein provides a communication method executed by a communication terminal. The communication method includes displaying a video captured by an image capturing apparatus; acquiring a three-dimensional model associated with an object to be masked, when the object to be masked is included in the video; and displaying the video in which the acquired three-dimensional model is superimposed on the object to be masked.

The present disclosure described herein provides a non-transitory recording medium storing a plurality of instructions which, when executed by one or more processors, causes the one or more processors to perform the above-described communication method.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a general arrangement of a communication system according to a first embodiment;

FIG. 2 is a diagram illustrating a hardware configuration of a first communication terminal according to the first embodiment;

FIG. 3 is a diagram illustrating a hardware configuration of a second communication terminal and an information processing system according to the first embodiment;

FIG. 4 is a block diagram illustrating a functional configuration of the communication system according to the first embodiment;

FIG. 5 is a diagram illustrating an example of three-dimensional model data management information according to the first embodiment;

FIG. 6 is a diagram illustrating a method for identifying a positional relationship between an image capturing apparatus and an object in the first embodiment;

FIGS. 7A and 7B are diagrams illustrating an example of mask processing for superimposing a three-dimensional model on an object in a video according to the first embodiment;

FIGS. 8A and 8B are diagrams illustrating examples of images of a work environment displayed on the first communication terminal and the second communication terminal according to the first embodiment;

FIG. 9 is a sequence diagram illustrating a communication method executed by the communication system according to the first embodiment;

FIG. 10 is a block diagram illustrating a functional configuration of a communication system according to a second embodiment; and

FIG. 11 is a sequence diagram illustrating a communication method executed by the communication system according to the second embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

### First Embodiment

### Example Configuration of Communication System

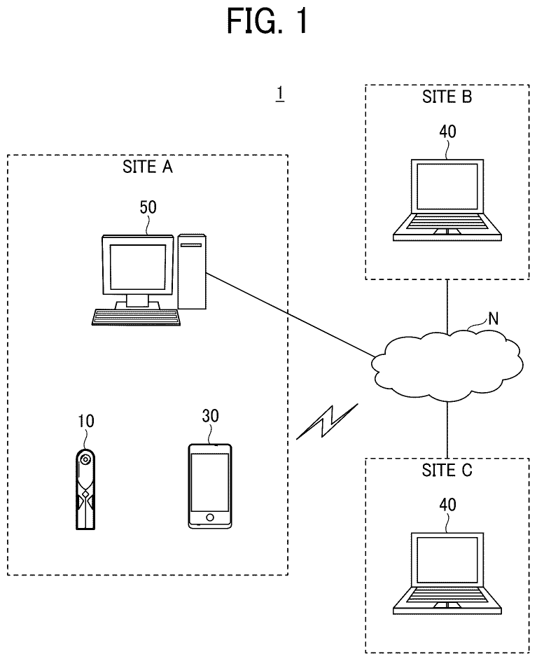

FIG. 1 is a diagram illustrating a general arrangement of a communication system 1 according to a first embodiment of the present disclosure. The communication system 1 is a system for bidirectionally transmitting and receiving a video captured by an image capturing apparatus 10 across a plurality of sites. In the communication system 1, an image distributed from one of the sites is displayed at the other sites and is viewable to users at the other sites. The video captured by the image capturing apparatus 10 is an image with a normal angle of view, but may be a wide-view image. In a case where the video is a wide-view image, a spherical image captured by the image capturing apparatus 10 that captures a wide-view image is distributed. A user can change a point of view (or viewpoint) of the wide-view image, as desired.

The term “wide-view image” refers to an image having a wide viewing angle in which a wide imaging range is captured by a predetermined imaging method. The wide-view image may include, for example, a 360-degree image that captures the entire surroundings of 360 degrees, and the 360-degree image is also referred to as a spherical image, an omnidirectional image, or an “all-around” image.

The wide-view image includes an image of a range wider than a display range that can be displayed on the display at a time in a predetermined display method. The wide-view image has a display range corresponding to a field of view of up to 360 degrees in the vertical direction and a field of view of up to 360 degrees in the horizontal direction. In an example, the wide-view image is an image having a display range corresponding to a field of view of less than 360 degrees in the vertical and horizontal directions as long as the wide-view image has a viewing angle in a wider range than the display range that can be displayed on the display at a time. The wide-view image also includes an image having a display range wider than a range that can be visually recognized at a time by a person looking at the range. Depending on the display method, an image that can be displayed on the display at a time is also included in the wide-view image as long as the image has a wide range of viewing angles in a predetermined display method.

In the present embodiment, a spherical image in equirectangular projection format is used as an example of a wide-view image. Other examples of the wide-view image include an omnidirectional image, a hemispherical image, a three-dimensional (3D) panoramic image, a two-dimensional (2D) panoramic image, and a virtual reality (VR) image. An image having a normal angle of view is not a wide-view image. In the present embodiment, such an image is referred to as a non-wide-view image, that is, a planar image.

In the communication system 1, the image capturing apparatus 10, a first communication terminal 30, an information processing system 50, which are placed at a site A, are communicably connected to second communication terminals 40 each placed at a respective one of a plurality of sites (e.g., sites B and C). The number of sites at which the second communication terminals 40 are placed is not limited to two, and may be one or three or more.

In one example, the site A is a workplace such as a factory or a construction site. These workplaces are merely examples, and the site A may be any other workplace or site such as a laboratory, an event venue, a store, or a medical setting. The sites B and C are any locations where communication using video is possible, such as offices. In the following description, a user who distributes an image using the image capturing apparatus 10 and the first communication terminal 30 at the site A is also referred to as an “imaging operator”, and users who perform an operation such as viewing a received image using the second communication terminals 40 at the sites B and C are also referred to as “participants”.

At this time, based on a video captured by the image capturing apparatus 10 at the site A, a video to be distributed from the first communication terminal 30 used by the imaging operator is generated and distributed to the second communication terminals 40 used by the participants via the information processing system 50. However, a flow of video distribution is not limited to this.

The image capturing apparatus 10 may be included in the first communication terminal 30. When the image capturing apparatus 10 is directly connectable to a network N, the image capturing apparatus 10 is connected to the network N without using the first communication terminal 30 as a relay device. In this case, the first communication terminal 30 is connected to the network N without the image capturing apparatus 10. The image capturing apparatus 10 may be connected to the network N via the first communication terminal 30 serving as a relay device, and a plurality of image capturing apparatuses 10 may be placed at the site A.

The first communication terminal 30, the second communication terminals 40, and the information processing system 50 are communicable with one another via the network N. The network N includes the Internet, a mobile communication network, and a local area network (LAN), for example. The network N may include a wired communication network and a wireless communication network. The wireless communication network may be based on a wireless communication standard such as third generation (3G), fourth generation (4G), fifth generation (5G), Wireless Fidelity (Wi-Fi®), Worldwide Interoperability for Microwave Access (WiMAX), or Long Term Evolution (LTE).

The image capturing apparatus 10 captures an image of a work environment. The work environment includes an object to be masked for confidentiality from a business perspective or to protect personal information. Examples of objects to be masked include, but are not limited to, various items such as apparatuses used for production of products or the like. A space may be masked. Other examples of objects to be masked include production equipment or the like that is a trade secret. The object to be masked may include a material and a space in which processing or the like is performed, by which a highly confidential process can be identified. The object to be masked may be an item or the like set in advance, or may be an object selected on a terminal apparatus or the like that distributes video. The object to be masked is hereinafter also referred to simply as an “object”.

A video captured by the image capturing apparatus 10 is an image captured with a normal angle of view, and may be a moving image or a still image. The video may be a wide-view image. When the video is a wide-view image, the image capturing apparatus 10 is a special digital camera that captures an image of the work environment to obtain two hemispherical images, from which a spherical image is generated. The video may include audio together with an image.

The first communication terminal 30 is a mobile terminal such as a smartphone used by the imaging operator at the site A, or may be a computer such as a personal computer (PC). The second communication terminals 40 are computers such as PCs used by the participants at the sites B and C, or may be mobile terminals such as smartphones.

The first communication terminal 30 and the second communication terminals 40 may each have installed therein software for executing image processing, such as Open Graphics Library for Embedded Systems (OpenGL ES). OpenGL ES is an example of software for executing image processing. Any other software may be used. In an example, when software for executing image processing is not installed, image processing may be executed using software received from the outside, or a result of image processing executed by external software may be received to display an image. That is, the first communication terminal 30 and the second communication terminals 40 can display a predetermined area, which is a portion of the wide-view image.

The first communication terminal 30 and the second communication terminals 40 can each change the point of view for the display range of the wide-view image, as desired, in response to the users' operation. The first communication terminal 30 and the second communication terminals 40 shift a virtual point of view in accordance with user operation input (including key input, drag, scroll, etc.) on a touch panel, a direction button, a mouse, a keyboard, a touch pad, or the like. As a result, the field-of-view range (predetermined area) is changed and displayed based on point-of-view information corresponding to the shifted point of view. In an example, the first communication terminal 30 is an apparatus to be worn by the user, such as VR goggles. In response to a change in the movement of the user wearing the first communication terminal 30, position information of the first communication terminal 30 is changed. In response to detection of the change in the position information, the virtual point of view is shifted in accordance with the detected position information to change the field-of-view range (predetermined area), based on point-of-view information corresponding to the shifted point of view, and the changed field-of-view range (predetermined area) is displayed.

The first communication terminal 30 acquires a video from the image capturing apparatus 10 via a wired cable such as a Universal Serial Bus (USB) cable and distributes the acquired video to the second communication terminals 40 at the other sites through the information processing system 50. The connection between the image capturing apparatus 10 and the first communication terminal 30 may be either a wired connection using a wired cable or a wireless connection using short-range wireless communication, for example. A plurality of first communication terminals 30 may be placed at the site A. The first communication terminal 30 and the second communication terminals 40 are each any computer on which a web browser or an application dedicated to an image distribution service operates. Arrangement of the image capturing apparatus 10, the first communication terminal 30, the second communication terminals 40, and the information processing system 50 illustrated in FIG. 1 is an example. Any other example of arrangement may be used.

The information processing system 50 includes one or more information processing apparatuses. The information processing system 50 manages and controls communication among the image capturing apparatus 10, the first communication terminal 30, and the second communication terminals 40 at the respective sites and manages the video to be transmitted and received. The information processing system 50 provides a platform on which a function of providing an image distribution service for distributing a video is available. The platform may be made available to a person, a company, or any other service provider that desires to provide an image distribution service, under contract. A service provider that provides an image distribution service to a user by using a platform is hereinafter referred to as a platform contractor to distinguish the service provider from a tenant that receives the image distribution service.

The information processing system 50 may publish an application programming interface (API) as a platform, and the platform contractor may use the API to provide various image distribution services. The platform contractor mainly develops software such as an application for calling the API or the screen to be displayed on the first communication terminal 30 and the second communication terminals 40. That is, the functions to be provided by the API, such as image distribution, are not developed from scratch. The tenant is an entity such as a company or an organization that has a contract with a service provider to receive an image distribution service. In the present embodiment, the service provider is the information processing system 50. Users and other items such as image capturing apparatuses and virtual rooms are registered in the tenant.

The information processing system 50 may be implemented by a single computer or a plurality of computers such that functions or features of the components of the information processing system 50 are divided into and assigned to the plurality of computers as appropriate. All or some of the functions of the information processing system 50 may be implemented by a server computer residing in a cloud environment or a server computer residing in an on-premises environment.

In FIG. 1, the image capturing apparatus 10 is placed at a construction site that is a work site, by way of example. The present embodiment is also applicable to VR education, event distribution, remote customer services, telemedicine services, and other situations. In VR education, the image capturing apparatus 10 is placed at a site such as a study room or a laboratory. Students can view a blackboard, an instrument, a sample, an experimental result, or the like from remote sites while changing the points of view as appropriate.

In event distribution, the image capturing apparatus 10 is placed in a venue of an event to be held on-site. Event participants such as an audience can view the details in the venue online from remote sites while changing the points of view as appropriate. The details in the venue include images of event performers, event participants, and event presenters, images of subjects involved in the event, such as products and exhibits, images of materials involved in the event, and images of the venue. The event may be held indoors or outdoors, and examples of the venue of the event include venues such as sports stadiums, concert halls, and theaters.

In remote customer services, for example, in customer services for a travel agency, the image capturing apparatus 10 is placed at each of travel destination sites. A customer can plan the itinerary from a remote site while changing the point of view as appropriate.

In telemedicine services, in one example, the image capturing apparatus 10 is placed in a medical setting such as an operating room. Medical people such as doctors, medical students, and persons related to medical instruments can view the performance of a doctor(s) and a nurse(s) during on-site medical treatment, the arrangement of medical instruments, the state of a patient, vitals, and the like from remote sites while changing the points of view as appropriate. The configuration of the communication system 1 is not limited to the illustrated example, and may have various configurations.

### Hardware Configuration

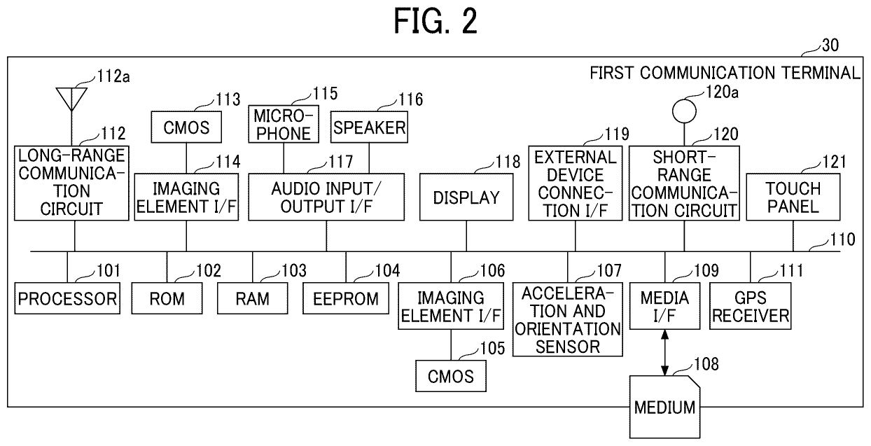

FIG. 2 is a diagram illustrating a hardware configuration of the first communication terminal 30. The illustrated configuration is a configuration in a case where the first communication terminal 30 is a mobile terminal. The hardware configuration of the first communication terminal 30 is not limited to the illustrated example.

As illustrated, the first communication terminal 30 includes a processor 101, a read-only memory (ROM) 102, a random access memory (RAM) 103, an electrically erasable programmable read-only memory (EEPROM) 104, a complementary metal oxide semiconductor (CMOS) sensor 105, an imaging element interface (I/F) 106, an acceleration and orientation sensor 107, a media I/F 109, and a Global Positioning System (GPS) receiver 111.

The processor 101 corresponds to a core portion of the first communication terminal 30. The processor 101 controls the components of the first communication terminal 30 to implement various functions of the first communication terminal 30 in accordance with an operating system or an application program. The processor 101 includes various arithmetic devices such as a central processing unit (CPU) and a graphics processing unit (GPU). The processor 101 is a multi-core processor including a plurality of processor cores and that executes a plurality of processing operations in parallel. The processor 101 reads various programs onto the RAM 103 and executes the programs.

The ROM 102 stores a program used for booting the processor 101. The RAM 103 is used as a work area for the processor 101. The EEPROM 104 reads or writes various types of data such as a smartphone program under the control of the processor 101.

The CMOS sensor 105 is an example of a built-in imaging device that captures an image of a subject under the control of the processor 101 to obtain image data. The first communication terminal 30 may include an imaging device other than a CMOS sensor, such as a charge-coupled device (CCD) sensor. The imaging element I/F 106 is a circuit that controls driving of the CMOS sensor 105. Examples of the acceleration and orientation sensor 107 include, but are not limited to, an electromagnetic compass or a gyrocompass for detecting geomagnetism and an acceleration sensor. The media I/F 109 controls reading of data from, writing of data to, and storing of data in a recording medium 108 such as flash memory. The GPS receiver 111 receives a GPS signal from a GPS satellite.

The first communication terminal 30 further includes a long-range communication circuit 112, an antenna 112a for the long-range communication circuit 112, a CMOS sensor 113, an imaging element I/F 114, a microphone 115, a speaker 116, an audio input/output I/F 117, a display 118, an external device connection I/F 119, a short-range communication circuit 120, an antenna 120a for the short-range communication circuit 120, and a touch panel 121.

The long-range communication circuit 112 is a circuit that communicates with other devices via the network N. The CMOS sensor 113 is an example of a built-in imaging device that captures an image of a subject under the control of the processor 101 to obtain image data. The imaging element I/F 114 is a circuit that controls driving of the CMOS sensor 113. The microphone 115 is a built-in circuit that converts audio into electrical signals. The speaker 116 is a built-in circuit that converts electrical signals into physical vibration to produce audio such as music or voice. The audio input/output I/F 117 is a circuit that processes the input and output of audio signals between the microphone 115 and the speaker 116 under the control of the processor 101.

The display 118 is an example of a display device such as a liquid crystal display (LCD) or an organic electroluminescent (EL) display that displays, for example, an image of a subject or various icons. The external device connection I/F 119 is an interface for connecting to various external devices. The short-range communication circuit 120 is a communication circuit in compliance with a communication standard such as near field communication (NFC) or Bluetooth®. The touch panel 121 is an example of an input device that allows a user to operate the first communication terminal 30 by touching a screen of the display 118.

The first communication terminal 30 further includes a bus line 110. The bus line 110 is, for example, an address bus or a data bus for electrically connecting the components illustrated in FIG. 2, such as the processor 101, to one another.

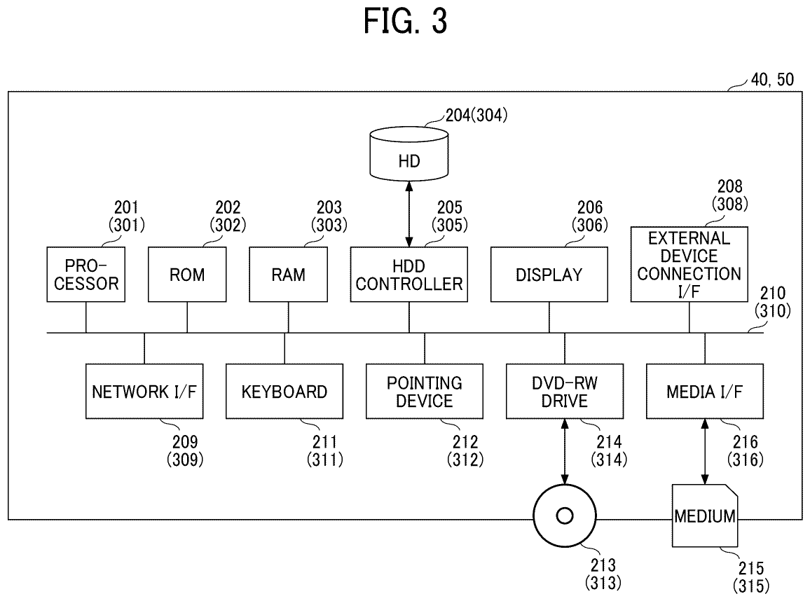

FIG. 3 is a diagram illustrating a hardware configuration of the second communication terminals 40 and the information processing system 50. The illustrated configuration is a configuration in a case where the second communication terminals 40 and the information processing system 50 are processing apparatuses such as servers. The hardware configuration of the second communication terminals 40 and the information processing system 50 is not limited to the illustrated example.

As illustrated, each of the second communication terminals 40 is implemented by one or more computers and includes a processor 201, a ROM 202, a RAM 203, a hard disk (HD) 204, a hard disk drive (HDD) controller 205, a display 206, an external device connection I/F 208, a network I/F 209, a data bus 210, a keyboard 211, a pointing device 212, a digital versatile disc rewritable (DVD-RW) drive 214, and a media I/F 216.

The processor 201 corresponds to a core portion of the second communication terminal 40. The processor 201 controls the components of the second communication terminal 40 to implement various functions of the second communication terminal 40 in accordance with an operating system or an application program. The processor 201 includes various arithmetic devices such as a CPU and a GPU. The processor 201 is a multi-core processor including a plurality of processor cores and configured to execute a plurality of processing operations in parallel. The processor 201 reads various programs onto the RAM 203 and executes the programs.

The ROM 202 stores a program used for booting the processor 201, such as an initial program loader (IPL). The RAM 203 is used as a work area for the processor 201. The HD 204 stores various types of data such as a program.

The HDD controller 205 controls reading or writing of various types of data from or to the HD 204 under the control of the processor 201. The display 206 displays various types of information such as a cursor, a menu, a window, characters, and an image. The external device connection I/F 208 is an interface for connecting to various external devices. The external devices include, for example, but are not limited to, a USB memory and a printer. The network I/F 209 is an interface for performing data communication using the network N. The data bus 210 is, for example, an address bus or a data bus for electrically connecting the components of the second communication terminal 40, such as the processor 201, to one another.

The keyboard 211 is an example of an input device provided with a plurality of keys for allowing a user to input characters, numerical values, or various instructions. The pointing device 212 is an example of an input device used for, for example, selecting or executing various instructions, selecting a target for processing, or moving a cursor being displayed. The DVD-RW drive 214 controls reading or writing of various data from or to a DVD-RW 213 as an example of a removable recording medium. The removable recording medium is not limited to a DVD-RW and may be, for example, a digital versatile disc recordable (DVD-R). The media I/F 216 controls reading of data from, writing of data to, and storing of data in a recording medium 215 such as flash memory.

As illustrated in FIG. 3, each hardware element of the information processing system 50 is denoted by a reference numeral in 300 series in parentheses. The information processing system 50 is implemented by one or more computers. As illustrated in FIG. 3, the information processing system 50 has substantially the same configuration as the second communication terminal 40, and thus the description of the hardware elements of the information processing system 50 will be omitted.

### Functional Configuration

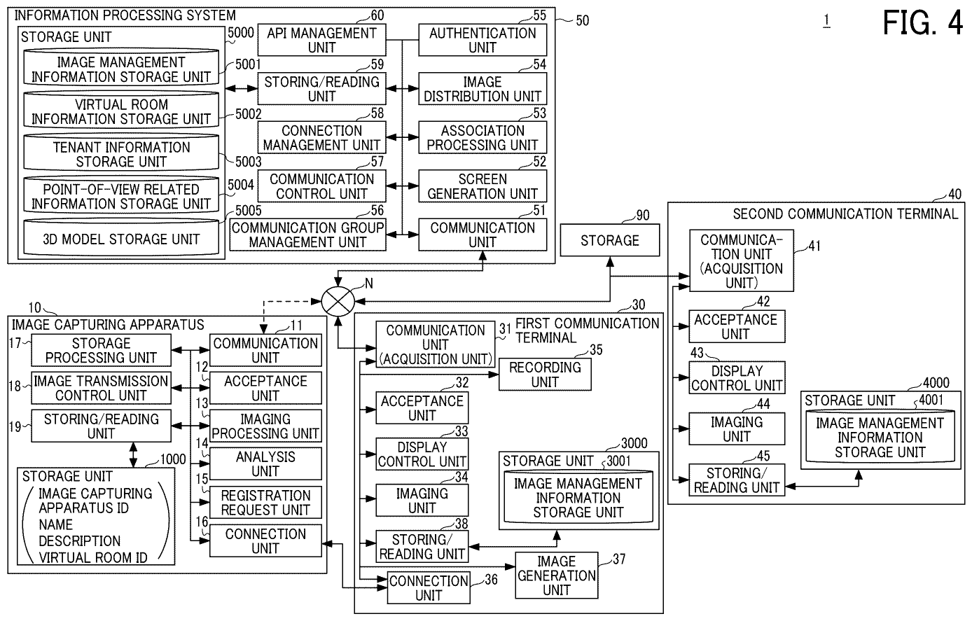

FIG. 4 is a block diagram illustrating a functional configuration of the communication system 1. The illustrated configuration is an example of the communication system 1.

### Functional Configuration of Image Capturing Apparatus

First, the functional configuration of the image capturing apparatus 10 will be described. The image capturing apparatus 10 includes a communication unit 11, an acceptance unit 12, an imaging processing unit 13, an analysis unit 14, a registration request unit 15, a connection unit 16, a storage processing unit 17, an image transmission control unit 18, and a storing/reading unit 19. The image capturing apparatus 10 further includes a storage unit 1000, which is implemented by, for example, a ROM.

The communication unit 11 connects to the network N using wireless communication technology such as Wi-Fi® to transmit and receive various types of data or information to and from other apparatuses. The acceptance unit 12 receives an operation input for the image capturing apparatus 10 from a user. The acceptance unit 12 accepts, for example, an operation for turning on or off the power, pressing or releasing a shutter button (to start or stop transmission of video), and an operation input for a touch panel, a button, or the like from the user.

The imaging processing unit 13 mainly captures an image of a work environment such as a factory, and generates and acquires a video. The video acquired by the imaging processing unit 13 is a moving image, but may be a still image captured at a paused point in the video, or may include both a still image and a moving image. The video may include audio together with an image. The imaging processing unit 13 captures an image of, for example, a marker disposed in the work environment.

The analysis unit 14 analyzes a two-dimensional code included in the marker, which is obtained from an image captured by the imaging processing unit 13, and extracts information included in the two-dimensional code. The information extracted by the analysis unit 14 includes a model ID or the like associated with three-dimensional model data for masking an object corresponding to each marker disposed in the work environment. The processing performed by the analysis unit 14 may be executed by the first communication terminal 30.

The registration request unit 15 transmits a request to the information processing system 50 via the communication unit 11 to register the image capturing apparatus 10 in a tenant of the information processing system 50. The connection unit 16 receives power supply from the first communication terminal 30 and performs data communication.

The storage processing unit 17 performs processing to store a video captured by the image capturing apparatus 10 in storage 90 or a location identified by a uniform resource locator (URL) transmitted from the information processing system 50. The storage 90 is a storage device separate from the information processing system 50. The storage 90 is cloud storage, by way of example. The storage 90 may be on-premises storage or may be storage included in the information processing system 50.

The image transmission control unit 18 controls transmission of video to the first communication terminal 30 and the information processing system 50. For example, the image transmission control unit 18 transmits a video acquired by the imaging processing unit 13 to the first communication terminal 30 and the information processing system 50 periodically or in accordance with a user operation when the video is a still image, and at a predetermined frame rate (expressed in frames per second, or FPS) when the video is a moving image. The image transmission control unit 18 also performs switching between the communication unit 11 and the connection unit 16.

The storing/reading unit 19 stores various types of data in the storage unit 1000 or reads various types of data from the storage unit 1000. The storage unit 1000 stores, for example, video data acquired by the imaging processing unit 13, identification information (e.g., an image capturing apparatus ID), a name, and a description of the image capturing apparatus 10, and a virtual ID that identifies a virtual room. The virtual room is a virtual group in which the image capturing apparatus 10, the first communication terminal 30, and the second communication terminals 40 participating in a conference or the like are managed as one unit.

The video data stored in the storage unit 1000 may be deleted when a predetermined time has elapsed after the video data was acquired by the imaging processing unit 13. Alternatively, data transmitted to the information processing system 50 or the like may be deleted from the storage unit 1000.

### Functional Configuration of First Communication Terminal and Second Communication Terminal

Next, functional configurations of the first communication terminal 30 and the second communication terminals 40 will be described. The first communication terminal 30 includes a communication unit 31, an acceptance unit 32, a display control unit 33, an imaging unit 34, a recording unit 35, a connection unit 36, an image generation unit 37, and a storing/reading unit 38.

Each unit of the first communication terminal 30 is a function or a unit implemented by or caused to function by one or more of the hardware elements illustrated in FIG. 2 operating in accordance with instructions from the processor 101 according to a program loaded onto the RAM 103.

The communication unit 31 is an example of an acquisition unit. The communication unit 31 connects to the network N and transmits and receives various types of data or information to and from other apparatuses. The acceptance unit 32 receives various selections or operation inputs for the first communication terminal 30. The display control unit 33 displays a video and various screens on the display 118. The display control unit 33 displays a video captured by the image capturing apparatus 10.

The display control unit 33 displays a video in which an acquired three-dimensional model is superimposed on an object to be masked. More specifically, the display control unit 33 calculates a position and an orientation of the object to be masked in the video, based on a positional relationship between the image capturing apparatus 10 and the object to be masked, and displays the video in which a three-dimensional model is superimposed on the object to be masked. The display control unit 33 displays a video in which at least one of a position and a shape of a three-dimensional model to be superimposed on an object to be masked is changed in accordance with a change in the position of the object to be masked in the displayed video. Calculation related to superimposition of the three-dimensional model on the object included in the video and processing related to generation of the video may be executed by the image generation unit 37 or by a screen generation unit 52 of the information processing system 50. The process executed by the display control unit 33 to display a video with a superimposed three-dimensional model may be executed by a display control unit 43 of each of the second communication terminals 40 or by the screen generation unit 52 of the information processing system 50.

The imaging unit 34 captures an image of a subject and surroundings of the first communication terminal 30. The recording unit 35 records a video captured by the image capturing apparatus 10 and a video distributed from the first communication terminal 30 to the second communication terminals 40, and stores recording data in a storage unit 3000 via the storing/reading unit 38. The connection unit 36 supplies power to the image capturing apparatus 10 and performs data communication.

The image generation unit 37 is implemented by a viewing application (or “viewing app”) and generates a video to be displayed and distributed. The image generation unit 37 may generate a thumbnail image of the video to be distributed.

The image generation unit 37 calculates, based on a positional relationship between the image capturing apparatus 10 and an object to be masked, a position and an orientation of the object in a video captured by the image capturing apparatus 10, and generates a video in which a three-dimensional model is superimposed on the object. More specifically, the image generation unit 37 detects a marker having a predetermined shape from the video, calculates a relative positional relationship between the image capturing apparatus 10 and the object, based on the position of the marker, and calculates the position and the orientation of the object in the video. Calculating the position and orientation of the object clearly identifies a region to be masked. The orientation of the object is a size and an orientation of the object in a three-dimensional space and is a concept that includes the direction of the object.

The image generation unit 37 generates a video in which mask processing is performed on at least a portion of the object to be masked. Not all portions of the object may be subjected to the mask processing, and the mask processing for the object may be performed on a portion of the object, such as a screen included in the object, a portion having a special shape, or a portion on which information desired to be kept confidential is described. In this case, the image generation unit 37 does not calculate the orientation of the object. The mask processing is, for example, processing for superimposing a three-dimensional model on at least a portion of the object. The three-dimensional model is a model associated with the object to be masked.

The image generation unit 37 can change at least one of a position and a shape of a three-dimensional model to be superimposed on an object to be masked, in accordance with a change in the position of the object to be masked in a video. Accordingly, even in the video distributed in real time, the three-dimensional model can follow movement of the object. The processing for superimposing the three-dimensional model on the video captured by the image capturing apparatus 10 may be executed by the display control unit 43 of each of the second communication terminals 40 or by the screen generation unit 52 of the information processing system 50.

The storing/reading unit 38 stores various types of data in the storage unit 3000 or reads various types of data from the storage unit 3000. The storage unit 3000 includes an image management information storage unit 3001. The image management information storage unit 3001 will be described in the description of the information processing system 50.

Each of the second communication terminals 40 includes a communication unit 41, an acceptance unit 42, the display control unit 43, an imaging unit 44, and a storing/reading unit 45. The storing/reading unit 45 stores various types of data in a storage unit 4000 or reads various types of data from the storage unit 4000. The storage unit 4000 includes an image management information storage unit 4001. The image management information storage unit 4001 will be described in the description of the information processing system 50. The communication unit 41 is an example of an acquisition unit.

Each unit of the second communication terminal 40 is a function or a unit implemented by or caused to function by one or more of the hardware elements illustrated in FIG. 3 operating in accordance with instructions from the processor 201 according to a program loaded onto the RAM 203. The functional components of the second communication terminal 40, namely, the communication unit 41, the acceptance unit 42, the display control unit 43, the imaging unit 44, and the storing/reading unit 45, have substantially the same configurations as the communication unit 31, the acceptance unit 32, the display control unit 33, the imaging unit 34, and the storing/reading unit 38 of the first communication terminal 30, respectively, and a description thereof will be omitted.

### Functional Configuration of Information Processing System

Next, the functional configuration of the information processing system 50 will be described. The information processing system 50 includes a communication unit 51, the screen generation unit 52, an association processing unit 53, an image distribution unit 54, an authentication unit 55, a communication group management unit 56, a communication control unit 57, a connection management unit 58, a storing/reading unit 59, and an API management unit 60. Each unit of the information processing system 50 is a function or a unit implemented by or caused to function by one or more of the hardware elements illustrated in FIG. 3 operating in accordance with instructions from the processor 301 according to a program loaded onto the RAM 303.

The communication unit 51 transmits and receives various types of data or information to and from other apparatuses via the network N. The screen generation unit 52 generates screen information to be displayed on the first communication terminal 30 and the second communication terminals 40. In a case where the first communication terminal 30 and the second communication terminals 40 execute a web application, the screen information is created by Hypertext Markup Language (HTML), Extensible Markup Language (XML), Cascading Style Sheets (CSS), JavaScript®, or any other language. In a case where the first communication terminal 30 and the second communication terminals 40 execute a native application, the screen information is held by the first communication terminal 30 and the second communication terminals 40, and the information to be displayed is transmitted in XML or the like. The screen generation unit 52 generates a video to be distributed by the image distribution unit 54 via the communication unit 51.

When the video is a wide-view image, the association processing unit 53 performs control related to association and sharing of point-of-view information of the wide-view image. In response to receipt of point-of-view information and an image capturing request from the first communication terminal 30 and the second communication terminals 40, the association processing unit 53 performs processing to associate the point-of-view information with a wide-view image acquired from the image capturing apparatus 10 in response to an image capturing request. The wide-view image and point-of-view information, which are associated with each other, are stored in an image management information storage unit 5001 by the storing/reading unit 59.

The image distribution unit 54 distributes an image, such as a wide-view image transmitted from the image capturing apparatus 10 associated with a virtual room, to the first communication terminal 30 operated by a user who is in the same virtual room as that associated with the image capturing apparatus 10, via the communication unit 51.

The authentication unit 55 authenticates, based on an authentication request received by the communication unit 51, the request source. For example, the authentication unit 55 determines whether authentication information (a user ID and a password) included in the authentication request received by the communication unit 51 matches authentication information held in advance to perform user authentication. The authentication information may be the card number of an integrated circuit (IC) card, biometric authentication information such as a face, a fingerprint, or a voiceprint, a device ID, a passcode, an access token, a security key, or a ticket. The authentication unit 55 may perform authentication using an external authentication system or an authentication method such as Open Authorization (OAuth). The authentication unit 55 may authenticate a device such as the image capturing apparatus 10, as well as a user.

The communication group management unit 56 manages entry of the first communication terminal 30 and the second communication terminals 40 into a virtual room, association of the image capturing apparatus 10 with the virtual room, and the like. When authentication by the authentication unit 55 is successful, the communication group management unit 56 registers a user ID, the Internet protocol (IP) address of the first communication terminal 30, and the IP addresses of the second communication terminals 40 in a virtual room information storage unit 5002, and associates the image capturing apparatus 10 with the virtual room.

The communication control unit 57 manages start, establishment, and termination of communication with the first communication terminal 30, the second communication terminals 40, and the image capturing apparatus 10 associated with each virtual room. The communication control unit 57 also manages start, establishment, and termination of communication for distributing a wide-view image and audio in accordance with entry of and exit from the virtual room by the first communication terminal 30 and the second communication terminals 40.

The connection management unit 58 is mainly implemented by processing of the processor 301, and manages communication established with the information processing system 50 by the image capturing apparatus 10, the first communication terminal 30, and the second communication terminals 40 in association with the virtual room.

The API management unit 60 manages an API to be used by a platform contractor to provide a video distribution service. In the use of the API, the platform contractor develops software for calling the API. The software to be developed operates on a server, or may operate on a client device.

Any functions of the information processing system 50, such as the image distribution unit 54, the association processing unit 53, and the communication control unit 57, can be provided as an API. A function added to the information processing system 50 later may be provided as an API. To determine whether to provide a function as an API, an apparatus operated by the platform provider accesses the information processing system 50 and receives the public settings of the API. As a result, the API management unit 60 can control the API based on the public settings. The API management unit 60 may perform an authentication process for checking whether software operating on a requesting entity that makes a request to call the API is software developed by an authorized platform contractor.

The authentication process can be performed by comparing information registered and stored in advance in a storage unit 5000 as information on the platform contractor with information transmitted from the software operating on the requesting entity. The application ID is an example of authentication information for determining validity. The API management unit 60 may use authentication information issued in advance by the API management unit 60 of the information processing system 50 to check the validity of the requesting entity. Examples of such authentication information as issued in advance include an access token, a ticket, a security key, and a password.

The storing/reading unit 59 stores various types of data in the storage unit 5000 or reads various types of data from the storage unit 5000. The storage unit 5000 includes the image management information storage unit 5001, the virtual room information storage unit 5002, a tenant information storage unit 5003, a point-of-view related information storage unit 5004, and a 3D model storage unit 5005.

The image management information storage unit 5001 stores image management information. The image management information is information that manages wide-view images captured in response to image capturing requests. In response to a user transmitting an image capturing request from the first communication terminal 30 or one of the second communication terminals 40, image management information for one record is generated. The image management information includes, for example, a data ID that is identification information for identifying video data, a data name that is the name of the wide-view image, imaging start date and time information, imaging operator information, image capturing apparatus information, an imaging-time virtual room ID, storage location information of data of the wide-view image, and a participant ID.

The virtual room information storage unit 5002 stores virtual room information. The virtual room information is information related to a virtual room. The virtual room information is held for each virtual room. The virtual room information includes, for example, a virtual room ID for identifying the virtual room, a virtual room name, and device information that is identification information for identifying a device including the image capturing apparatus 10 associated with the virtual room.

The tenant information storage unit 5003 stores tenant information. The tenant information is information related to a tenant (user group). The tenant information is held for each tenant. The tenant information includes, for example, a tenant ID for identifying the tenant, a tenant name, a tenant-registered virtual room ID that is identification information for identifying a virtual room registered in the tenant, and tenant-registered devices that are information related to devices registered in the tenant.

The point-of-view related information storage unit 5004 stores point-of-view related information. In the point-of-view related information, a data ID of a wide-view image, a participant ID, viewing start date and time information, and storage location information of point-of-view information are associated with each other.

### Three-Dimensional Model Data Management Information

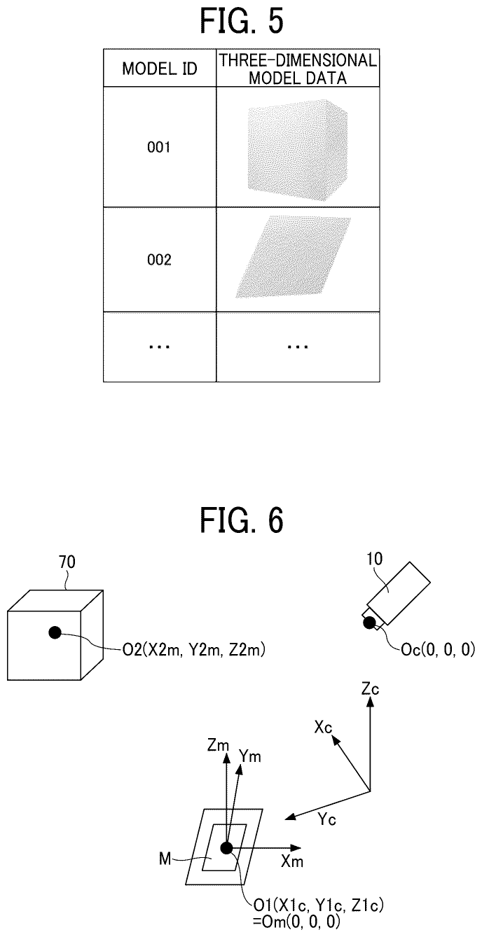

FIG. 5 is a diagram illustrating an example of three-dimensional model data management information. The three-dimensional model data management information is stored in the 3D model storage unit 5005 of the information processing system 50. In the three-dimensional model data management information, a model ID and a three-dimensional model are associated and managed for each item of three-dimensional model data. The three-dimensional models are not limited to shapes illustrated in FIG. 5 and may have various shapes. The three-dimensional model data management information may be stored in the storage unit 3000 of the first communication terminal 30 or may be stored in the storage unit 4000 of each of the second communication terminals 40.

The model ID is an example of three-dimensional model identification information for identifying a three-dimensional model. The three-dimensional model is an image created in advance by a user. The three-dimensional model has any shape such as a cube, a rectangular parallelepiped, or a sphere, as illustrated. The three-dimensional model may be a binary data file such as a GL Transmission Format (glTF) file or a GL Binary (glb) file, or may be in a text-based format such as 3D Extensible Markup Language (3DXML). The three-dimensional model may be created using 3D computer graphics (CG) creation software such as Blender®.

In the three-dimensional model data management information, attribute information may be associated and managed for each ID of three-dimensional model data. The attribute information includes, for example, identification information for identifying the object, installation location information of the object, and construction date information of the object. The installation location information of the object may include coordinates indicating the position of the object.

Alignment of the three-dimensional model with the object may be based on the installation location information of the object. More specifically, the first communication terminal 30 superimposes the acquired three-dimensional model on the object to be masked, based on the position of the image capturing apparatus 10 at the time when the video is captured and the installation location information of the object. It is desirable to determine the position of a vertex of the three-dimensional model for alignment when the three-dimensional model is to be superimposed on the object and the range over which the three-dimensional model is to be superimposed on the object. The range over which the three-dimensional model is to be superimposed on the object may be a portion of the object and may be any range within which confidentiality is to be protected.

The three-dimensional model superimposed on the object to be masked visually conceals a surface of the object from the participants on the second communication terminals 40. As a result, the confidentiality of the object can be protected. Further, superimposition of the three-dimensional model on the object reduces visual discomfort for a user viewing the video as compared with mosaic processing or blur processing. Such superimposition enables the user to recognize what the object is while concealing confidential information such as a screen from the user.

Identification of Positional Relationship between Image Capturing Apparatus and Object

A method for identifying a positional relationship between the image capturing apparatus 10 and an object 70 by the image generation unit 37 of the first communication terminal 30 will be described with reference to FIG. 6. FIG. 6 is a diagram illustrating a method for identifying a positional relationship between the image capturing apparatus 10 and the object 70 in the first embodiment. In FIG. 6, a marker M is illustrated. A positional relationship between the marker M and the object 70 is known.

In FIG. 6, a camera coordinate system has an origin represented as Oc(0, 0, 0). The origin Oc is a focal point of an actual camera, but may be a position different from the focal point of the camera. The camera coordinate system includes three dimensions represented as (Xc, Yc, Zc). An Xc-Yc plane is, for example, a plane parallel to an imaging element surface of the camera. A Zc-axis is, for example, an axis perpendicular to the imaging element surface.

The marker M is at a position O1 represented by coordinates (X1c, Y1c, Z1c) in the camera coordinate system. The coordinates (X1c, Y1c, Z1c) of the position O1 in the camera coordinate system are calculated based on coordinate values of four corners of the marker M in the video.

The positional relationship between the marker M and the object 70 is known and is represented in a marker coordinate system. The marker coordinate system has an origin represented as Om(0, 0, 0). The origin Om is, for example, but not limited to, the center of the marker M. The marker coordinate system includes three dimensions represented as (Xm, Ym, Zm). For example, an Xm-Ym plane of the marker coordinate system is a plane parallel to the marker M, and a Zm-axis is an axis perpendicular to a surface of the marker M. The marker coordinate system is defined such that each coordinate unit corresponds to one marker M in image data. The object 70 has a center O2 represented by coordinates (X2m, Y2m, Z2m) in the marker coordinate system.

Various methods are used to calculate the positional relationship between the image capturing apparatus 10 and the object 70 based on the coordinates (X1c, Y1c, Z1c) of the position O1 of the marker M in the camera coordinate system and the coordinates (X2m, Y2m, Z2m) of the position O2 of the object 70 in the marker coordinate system. The positional relationship is calculated using, for example, a method disclosed in Kato, Hirokazu., Mark Billinghurst., Koichi Asano., and Keihachiro Tachibana., “An Augmented Reality System and its Calibration based on Marker Tracking.”, Transactions of the Virtual Reality Society of Japan (TVRSJ), volume 4, no. 4, pp. 607-616, 1999, specifically, in “2. Marker position detection method” in pp. 608-612, which is hereby incorporated by reference herein.

As described above, the image generation unit 37 estimates both or either of the position and the orientation of the object 70 in the video, which is a virtual space, based on information on a region in which an image of the marker M is captured in the video and information on the position and the direction of the marker M.

Generation of Video in which Three-Dimensional Model is Superimposed on Object

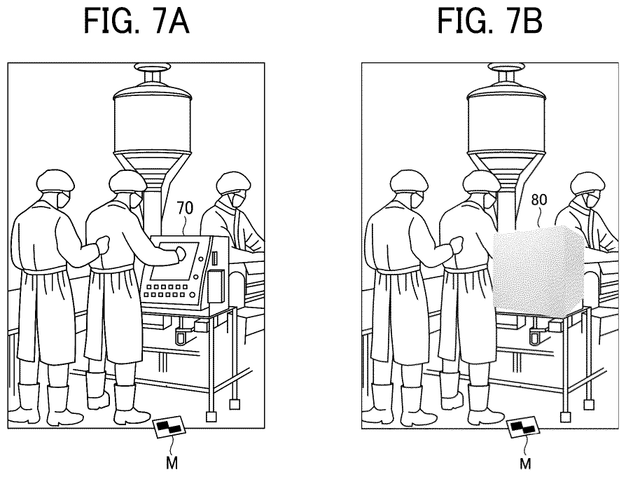

FIGS. 7A and 7B are diagrams illustrating an example of mask processing for superimposing a three-dimensional model 80 on the object 70 in a video according to the first embodiment. FIG. 7A illustrates an example of a video of a work environment captured by the image capturing apparatus 10. FIG. 7B illustrates an example of a video generated by the image generation unit 37. In the generated video, mask processing has been performed on the object 70.

As illustrated in FIGS. 7A and 7B, the marker M is disposed in the work environment. The marker M is an image including a two-dimensional code formed on a sheet-like medium such as paper. The marker M is, for example, a square image having a side of 5 cm. The marker M is disposed at a location such as a floor surface or a wall surface for each corresponding object 70. However, one marker M may be disposed for a plurality of objects 70.

The position of the marker M and the position of the object 70 are associated with each other in advance. Accordingly, the marker M may be located at any position, and is not limited to directly beneath the object 70. The two-dimensional code of the marker M includes position information indicating the position of the object 70. The position information is, for example, coordinates of the object 70 in the marker coordinate system.

As described with reference to FIG. 6, since the positional relationship between the marker M and the object 70 is known, the image generation unit 37 of the first communication terminal 30 can identify the positional relationship between the image capturing apparatus 10 and the object 70. In addition, since a range over which the three-dimensional model is to be superimposed on the object 70 is also known, the size of the three-dimensional model to be superimposed can also be identified. The image generation unit 37 performs processing for superimposing the three-dimensional model 80 on the object 70 to be masked.

The first communication terminal 30 extracts the object 70 and the marker M from a video being captured of the work environment. The image generation unit 37 acquires a model ID from the two-dimensional code included in the marker M. Another known acquisition method may be used to acquire the model ID.

The model ID is data associated with the three-dimensional model 80 for masking the corresponding object 70. The model ID is, for example, character string information or numerical information for identifying the three-dimensional model 80. The first communication terminal 30 acquires the three-dimensional model 80 associated with the model ID, based on the three-dimensional model data management information, and superimposes the three-dimensional model 80 on the object 70. At this time, as illustrated in FIG. 7B, the image generation unit 37 generates a video in which the three-dimensional model 80 is superimposed on the object 70 to be masked.

Not all portions of the object 70 may be subjected to mask processing for superimposing a three-dimensional model on the object 70, and the mask processing may be performed on a portion of the object 70, such as a screen included in the object 70, a portion having a special shape, or a portion on which information desired to be kept confidential is described.

### User Interface

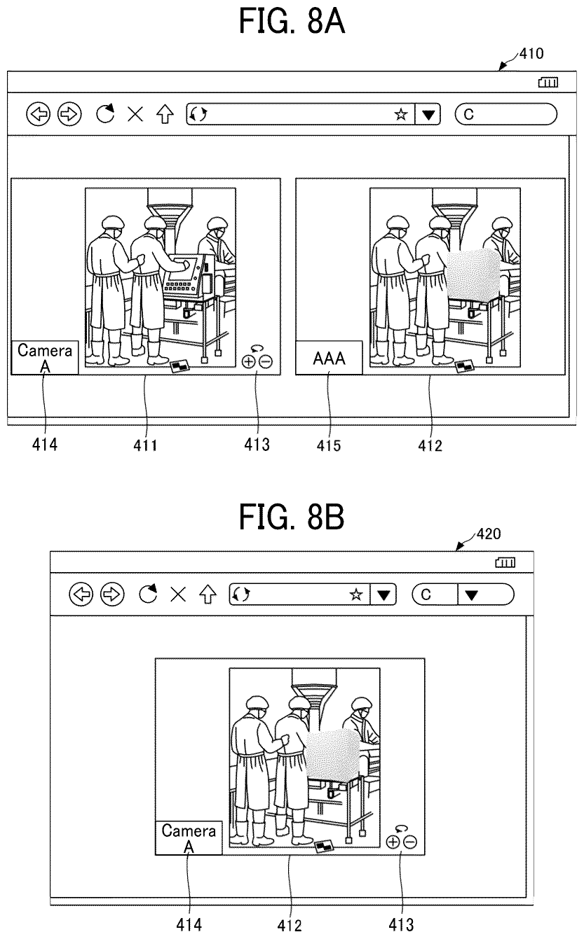

FIGS. 8A and 8B are diagrams illustrating examples of images of a work environment displayed on the first communication terminal 30 and the second communication terminals 40 according to the first embodiment. FIG. 8A illustrates an image check screen 410 displayed on the first communication terminal 30 used by the imaging operator. FIG. 8B illustrates an image viewing screen 420 displayed on the second communication terminals 40 used by the participants.

As illustrated in FIG. 8A, the image check screen 410 on the first communication terminal 30 includes a first image area 411 and a second image area 412. The first image area 411 displays a video captured by the image capturing apparatus 10. The second image area 412 displays a video in which a three-dimensional model is superimposed on at least a portion of the object 70.

The first image area 411 displays a wide-view image mark 413. When the image displayed in the first image area 411 is not a wide-view image, the wide-view image mark 413 is not displayed. The first image area 411 also displays a device name 414. The device name 414 is transmitted from the image capturing apparatus 10 together with the wide-view image. The device name 414 is set by, for example, the imaging operator. The second image area 412 displays a participant name 415 of a user of a second communication terminal 40 that is connected. A plurality of participant names 415 may be displayed.

As illustrated in FIG. 8B, the image viewing screen 420 on the second communication terminals 40 includes the second image area 412, which displays the video in which the three-dimensional model is superimposed on at least a portion of the object 70. When a video is distributed from three or more sites, the second image area 412 is divided according to the number of sites as distribution sources. The second image area 412 displays the wide-view image mark 413 and the device name 414, as in the first image area 411 on the first communication terminal 30. When the image displayed in the first image area 411 is not a wide-view image, the wide-view image mark 413 is not displayed.

### Communication Method

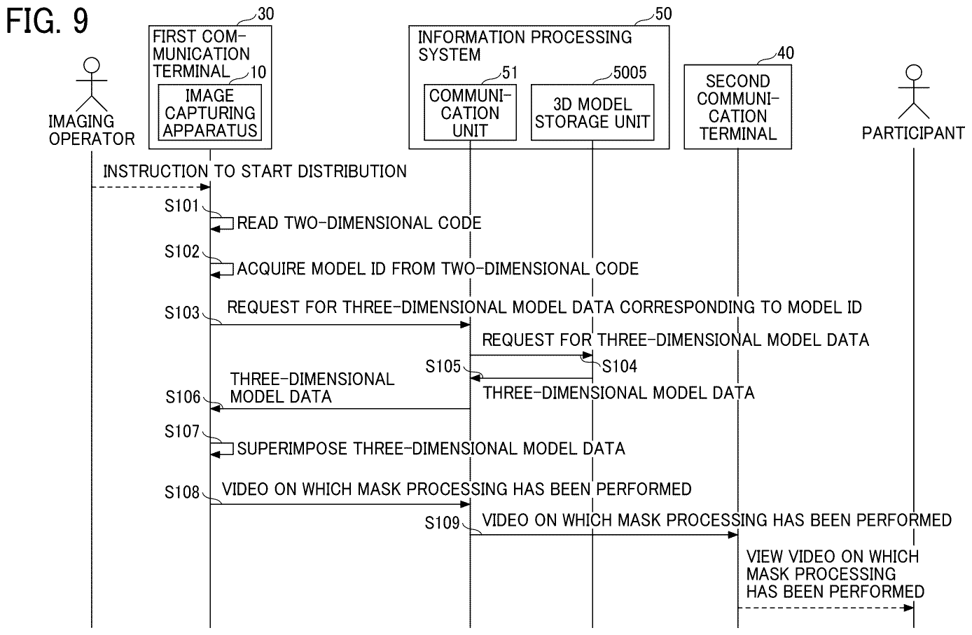

FIG. 9 is a sequence diagram illustrating a communication method executed by the communication system 1 according to the first embodiment. In the following description, it is assumed that the image capturing apparatus 10 is included in the first communication terminal 30 used by the imaging operator.

First, the imaging operator operates the display 118 illustrated in FIG. 2 to issue an instruction to start distribution of a video of the work environment from the first communication terminal 30, and the acceptance unit 32 accepts the operation. The image generation unit 37 extracts the marker M from a video captured by the image capturing apparatus 10 and reads a two-dimensional code (step S101). Examples of the two-dimensional code include a QR code®, a DataMatrix code, a MaxiCode code, and a PDF417 code. The two-dimensional code is read using a two-dimensional code reading screen displayed on the display 118 of the first communication terminal 30.

The image generation unit 37 reads the two-dimensional code included in the marker M and acquires a model ID (step S102). When the video includes the object 70 to be masked, the communication unit 31, which is an example of an acquisition unit of the first communication terminal 30, transmits an acquisition request to the communication unit 51 of the information processing system 50 to acquire three-dimensional model data corresponding to the acquired model ID (step S103), and the 3D model storage unit 5005 of the information processing system 50 is searched (step S104). The acquisition request is transmitted by an application program of the first communication terminal 30.

At this time, access from the first communication terminal 30 to the information processing system 50 is, for example, web access (Hypertext Transfer Protocol Secure (HTTPS)/Hypertext Transfer Protocol (HTTP)), but may be access via Message Queuing Telemetry Transport (MQTT) or Remote Procedure Call (RPC). Acquisition of the three-dimensional model data from the 3D model storage unit 5005 in the information processing system 50 is performed using, for example, a relational database (RDB). The three-dimensional model data is acquired from the 3D model storage unit 5005 (step S105). At this time, the communication unit 31, which is an example of an acquisition unit of the first communication terminal 30, acquires the three-dimensional model 80 associated with the object 70 to be masked (step S106).

The image generation unit 37 of the first communication terminal 30 identifies a positional relationship between the image capturing apparatus 10 and the object 70, based on the position of the marker M, and calculates the position and the orientation of the object 70 in the video captured by the image capturing apparatus 10, based on the positional relationship. The image generation unit 37 superimposes the three-dimensional model 80 on at least a portion of the object 70 and generates a video to be distributed (step S107).

In accordance with a change in the position of the object 70, such as movement of the image capturing apparatus 10, the image generation unit 37 changes at least one of the relative position and the shape of a region on which the three-dimensional model 80 is superimposed. Accordingly, even in the video distributed in real time, the three-dimensional model 80 can follow movement of the object 70.

The first communication terminal 30 distributes a video on which mask processing for superimposing the three-dimensional model 80 on the object 70 has been performed to the information processing system 50 (step S108). The information processing system 50 distributes the video to the second communication terminal 40 used by a participant (step S109). The participant uses the second communication terminal 40 to view the video in which mask processing has been performed on the object 70. The video is distributed from the first communication terminal 30 to the second communication terminal 40 via the information processing system 50 by using a communication protocol such as Web Real-Time Communication (WebRTC).

The steps described above implement a communication method according to the first embodiment. However, the communication method according to the first embodiment may include other steps as appropriate in accordance with measurement conditions, a measurement environment, and the like.

### Modifications

In the example described above, the first communication terminal 30 superimposes the three-dimensional model 80 on at least a portion of the object 70 to perform mask processing. The following describes, as a modification of the mask processing, an example in which blur processing is performed on at least a portion of the object 70.

In the modification, the image generation unit 37 of the first communication terminal 30 generates a video in which blur processing is performed on at least a portion of the object 70. The blur processing is applied by performing smoothing processing in a region corresponding to at least a portion of the object 70. The smoothing processing is performed using, for example, a smoothing filter included in the image generation unit 37. The smoothing processing is performed on an adjacent difference image, which is generated by, for example, performing edge detection processing. The adjacent difference image may be a difference image computed from adjacent pixels. Examples of the smoothing filter include a Gaussian filter, an averaging filter, and a median filter.

The video in which blur processing is performed on at least a portion of the object 70 allows the participant viewing the video using the second communication terminal 40 to more easily recognize that mask processing has been performed.

Examples of the mask processing may include, in addition to the blur processing described above, filling the object 70 with a predetermined color or an image pattern such as a checker pattern, stripes, a noise pattern, or a stamp, and mosaic processing.

The first communication terminal 30 acquires a three-dimensional model associated with an object 70 to be masked included in a video captured by the image capturing apparatus 10, and displays a video in which the three-dimensional model is superimposed on the object 70. The first communication terminal 30 calculates the position and the orientation of the object 70 in the video, based on the positional relationship between the image capturing apparatus 10 and the object 70, and superimposes the three-dimensional model on the object 70.

The communication terminal according to the present embodiment enables the object 70 to be appropriately masked by using a three-dimensional model.

### Second Embodiment

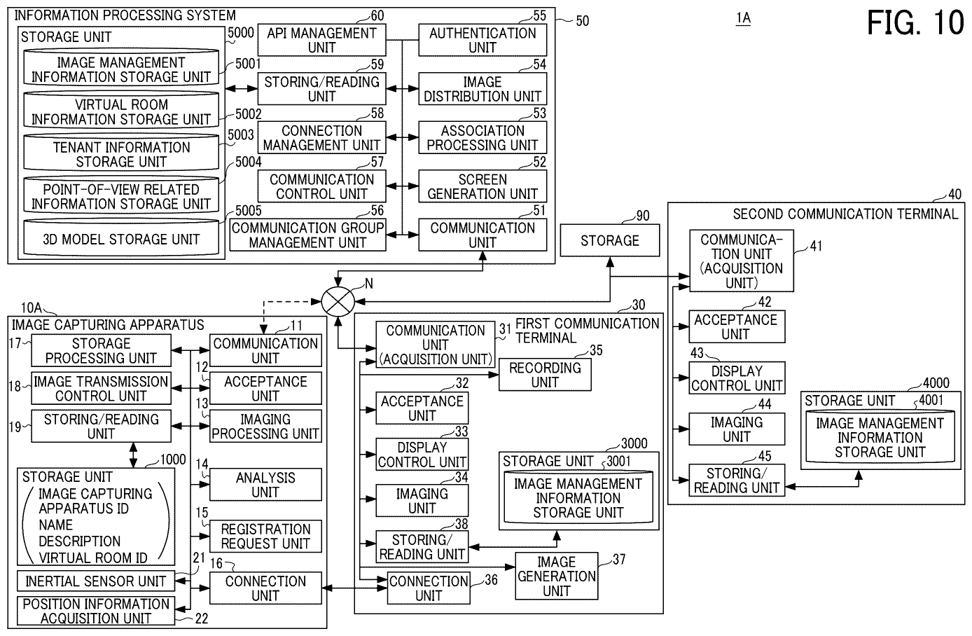

FIG. 10 is a block diagram illustrating a functional configuration of a communication system 1A according to a second embodiment of the present disclosure. The communication system 1A includes an image capturing apparatus 10A. The image capturing apparatus 10A further includes an inertial sensor unit 21 and a position information acquisition unit 22 in addition to the components of the image capturing apparatus 10 described above in the first embodiment. The same or substantially the same components as those described above are denoted by the same reference numerals, and a redundant description thereof will be omitted.

The inertial sensor unit 21 and the position information acquisition unit 22 are examples of sensors that detect at least one of the position, the movement direction, and the movement speed of the image capturing apparatus 10A. The inertial sensor unit 21 of the image capturing apparatus 10A is an example of a sensor that detects at least one of the movement direction and the movement speed of the image capturing apparatus 10A. The inertial sensor unit 21 is a sensor that detects three-axis acceleration and angular velocity applied to the image capturing apparatus 10A, and includes, for example, an acceleration sensor and a gyro sensor. The gyro sensor is an example of an angular velocity sensor.

The position information acquisition unit 22 is an example of a sensor that detects the position of the image capturing apparatus 10A. The position information acquisition unit 22 includes a GPS receiver. The GPS receiver acquires position information of the image capturing apparatus 10A, based on a signal received from a GPS satellite. The acquisition of the position information is not limited to a method using a GPS receiver.

The image generation unit 37 of the first communication terminal 30 identifies a positional relationship between the image capturing apparatus 10A and the object 70, based on information from the inertial sensor unit 21 and the position information acquisition unit 22 of the image capturing apparatus 10A. Accordingly, even when the object 70 is detected but the marker M is not detected from the video, the image generation unit 37 identifies the positional relationship between the image capturing apparatus 10A and the object 70.

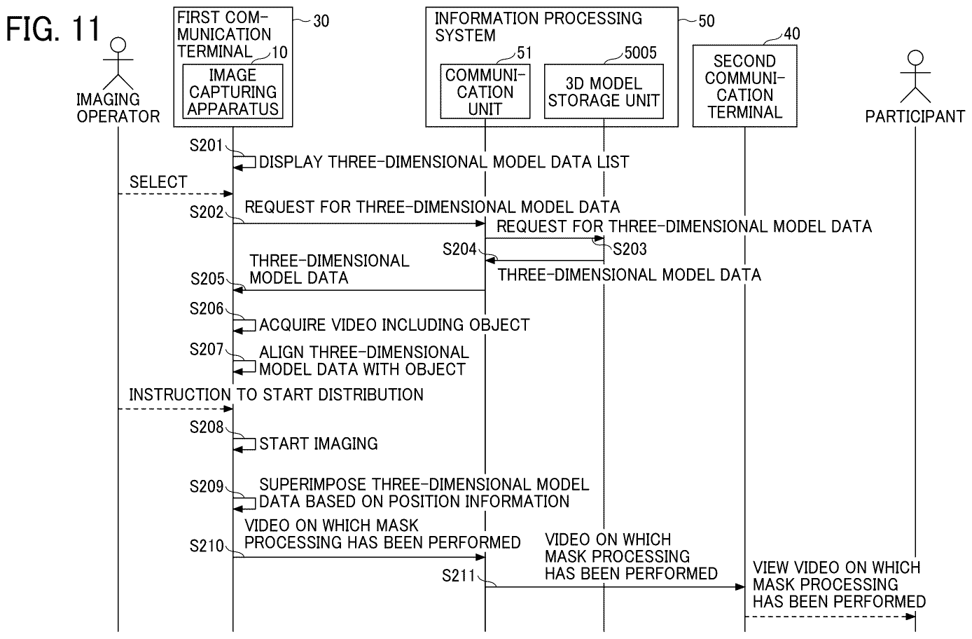

FIG. 11 is a sequence diagram illustrating a communication method executed by the communication system 1A according to the second embodiment. In the following description, it is assumed that the image capturing apparatus 10A is included in the first communication terminal 30 used by the imaging operator and the object 70 to be masked is included but the marker M is not included in the video.

First, the first communication terminal 30 displays a three-dimensional model data list that can be displayed superimposed on the object 70 (step S201). The three-dimensional model data list is stored in the storage unit 3000. The imaging operator performs an operation for selecting three-dimensional model data on the first communication terminal 30, and the acceptance unit 32 accepts the operation.

The first communication terminal 30 transmits an acquisition request to the communication unit 51 of the information processing system 50 to acquire the three-dimensional model data selected by the user (i.e., the imaging operator) (step S202), and the 3D model storage unit 5005 of the information processing system 50 is searched (step S203). The three-dimensional model data is extracted from the 3D model storage unit 5005 (step S204) and transmitted to the first communication terminal 30. The communication unit 31, which is an example of an acquisition unit, acquires the three-dimensional model 80 associated with the object 70 to be masked (step S205).

The first communication terminal 30 acquires a video including the object 70 (step S206). Subsequently, the three-dimensional model 80 acquired from the information processing system 50 is aligned with a portion of the object 70 in which confidentiality is to be protected, by a user operation or automatically (step S207). The imaging operator operates the display 118 illustrated in FIG. 2 to issue an instruction to start distribution of a video of the work environment from the first communication terminal 30, and the acceptance unit 32 receives the operation input. Then, imaging is started (step S208). The acceptance unit 32 may receive an instruction from the imaging operator to start distribution of video after imaging is started.

The image generation unit 37 generates a video in which the three-dimensional model 80 is superimposed on at least a portion of the object 70, based on the positional relationship between the object 70 and the image capturing apparatus 10A identified based on the position information acquired from the position information acquisition unit 22 (step S209).

In accordance with a change in the position of the object 70, such as movement of the image capturing apparatus 10A, the image generation unit 37 changes at least one of the relative position and the shape of a region on which the three-dimensional model 80 is superimposed in the video. The change in the position of the object 70 is detected based on information acquired from the inertial sensor unit 21. Accordingly, even in the video distributed in real time, the three-dimensional model 80 can follow movement of the object 70.

The first communication terminal 30 distributes a video on which mask processing for superimposing the three-dimensional model 80 on the object 70 has been performed to the information processing system 50 (step S210). The information processing system 50 distributes the video to the second communication terminal 40 used by a participant (step S211). The participant uses the second communication terminal 40 to view the video in which mask processing has been performed on the object 70.

The steps described above implement a communication method according to the second embodiment. However, the communication method according to the second embodiment may include other steps as appropriate in accordance with measurement conditions, a measurement environment, and the like.

The first communication terminal 30, which is an example of a communication terminal, identifies a positional relationship between the image capturing apparatus 10A and the object 70, based on information from a sensor that detects at least one of the position, the movement direction, and the movement speed of the image capturing apparatus 10A. The first communication terminal 30 calculates the position and the orientation of the object 70 in the video captured by the image capturing apparatus 10A, based on the identified positional relationship. The first communication terminal 30 performs mask processing on at least a portion of the object 70 to generate a video.

The communication terminal according to the present embodiment enables the object 70 to be appropriately masked using a three-dimensional model even when the marker M is not detectable.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

For example, aspects of the present disclosure include the following.

In a first aspect, a communication terminal includes a display control unit and an acquisition unit. The display control unit displays a video captured by an image capturing apparatus. The acquisition unit acquires a three-dimensional model associated with an object to be masked, when the object to be masked is included in the video. The display control unit displays the video in which the acquired three-dimensional model is superimposed on the object to be masked.

According to a second aspect, in the communication terminal of the first aspect, the display control unit calculates a position and an orientation of the object to be masked in the video, based on a positional relationship between the image capturing apparatus and the object to be masked, and displays the video in which the three-dimensional model is superimposed on the object to be masked.

According to a third aspect, in the communication terminal of the first aspect or the second aspect, the display control unit displays the video in which at least one of a position or a shape of the three-dimensional model to be superimposed on the object to be masked is changed in accordance with a change in a position of the object to be masked in the video.

According to a fourth aspect, in the communication terminal of any one of the first to third aspects, the display control unit detects a marker having a predetermined shape from the video, calculates, based on a position of the marker, a relative positional relationship between the image capturing apparatus and the object to be masked, and displays the video in which the three-dimensional model is superimposed on the object to be masked.

According to a fifth aspect, in the communication terminal of any one of the first to fourth aspects, the display control unit identifies a positional relationship between the image capturing apparatus and the object to be masked, based on information from a sensor that detects at least one of a position, a movement direction, or a movement speed of the image capturing apparatus.

In a sixth aspect, a communication system for distributing a video captured by an image capturing apparatus includes an acquisition unit and a display control unit. The acquisition unit acquires a three-dimensional model associated with an object to be masked, when the object to be masked is included in the video. The display control unit displays the video in which the acquired three-dimensional model is superimposed on the object to be masked.

In a seventh aspect, a communication method executed by a communication terminal includes displaying a video captured by an image capturing apparatus; acquiring a three-dimensional model associated with an object to be masked, when the object to be masked is included in the video; and displaying the video in which the acquired three-dimensional model is superimposed on the object to be masked.

In an eighth aspect, a program causes a communication terminal to execute a process including displaying a video captured by an image capturing apparatus; acquiring a three-dimensional model associated with an object to be masked, when the object to be masked is included in the video; and displaying the video in which the acquired three-dimensional model is superimposed on the object to be masked.

1. A communication terminal comprising circuitry configured to:
display a video captured by an image capturing apparatus;
acquire a three-dimensional model associated with an object to be masked, when the object to be masked is included in the video; and
display the video in which the acquired three-dimensional model is superimposed on the object to be masked.

2. The communication terminal according to claim 1, wherein the circuitry is configured to:
calculate a position and an orientation of the object to be masked in the video, based on a positional relationship between the image capturing apparatus and the object to be masked; and
display the video in which the three-dimensional model is superimposed on the object to be masked, based on the calculated position and orientation.

3. The communication terminal according to claim 1, wherein the circuitry is configured to display the video in which at least one of a position or a shape of the three-dimensional model to be superimposed on the object to be masked is changed in accordance with a change in a position of the object to be masked in the video.

4. The communication terminal according to claim 1, wherein the circuitry is configured to:
detect a marker having a predetermined shape from the video;
calculate, based on a position of the marker, a relative positional relationship between the image capturing apparatus and the object to be masked; and
display the video in which the three-dimensional model is superimposed on the object to be masked.

5. The communication terminal according to claim 1, wherein the circuitry is configured to identify a positional relationship between the image capturing apparatus and the object to be masked, based on information from a sensor that detects at least one of a position, a movement direction, or a movement speed of the image capturing apparatus.

6. A communication system comprising:
the communication terminal according to claim 1; and
an information processing system including system circuitry configured to distribute a video on which mask processing for superimposing the three-dimensional model on the object to be masked has been performed.

7. A communication method comprising:
displaying a video captured by an image capturing apparatus;
acquiring a three-dimensional model associated with an object to be masked, when the object to be masked is included in the video; and
displaying the video in which the acquired three-dimensional model is superimposed on the object to be masked.

8. A non-transitory recording medium storing a plurality of instructions which, when executed by one or more processors, causes the one or more processors to perform a communication method comprising:
displaying a video captured by an image capturing apparatus;
acquiring a three-dimensional model associated with an object to be masked, when the object to be masked is included in the video; and
displaying the video in which the acquired three-dimensional model is superimposed on the object to be masked.
